(19) United States
(12) Patent Application Publication
(10) Pub. No.: US 2026/0369915 A1
(43) Pub. Date: Nov. 19, 2026

(54) INLET CAP

(71) Applicant: Yazaki Corporation, Tokyo (JP)

(72) Inventor: Asuma NAGAI, Shizuoka (JP)

(73) Assignee: Yazaki Corporation, Tokyo (JP)

(21) Appl. No.: 19/671,513

(22) Filed: May 8, 2026

(30) Foreign Application Priority Data
May 14, 2025 (JP) 2025-081177

(51) Int. Cl. H01R 13/447; B60L 53/16

(52) U.S. Cl. CPC H01R 13/447; B60L 53/16; H01R 2201/26

(57) ABSTRACT

An inlet cap includes a cap body and a fitting wall, and the fitting wall includes a substantially tubular peripheral wall. Further, the fitting wall includes a rib formed on an outer peripheral surface of the peripheral wall so as to extend in the extension direction of the peripheral wall, and abutting against an inner circumferential surface of an inlet housing defining a through hole in a state where the peripheral wall is inserted into a space. Further, the fitting wall is configured such that, in a state of being inserted and fitted into the space, an end portion on the cap body side does not abut against the inner circumferential surface.

### CROSS-REFERENCE TO RELATED APPLICATIONS

The present application is based on, and claims priority from the Japanese Patent Application No. 2025-081177, filed on May 14, 2025, the entire contents of which are incorporated herein by reference.

### TECHNICAL FIELD

The disclosure relates to an inlet cap.

### BACKGROUND

As disclosed in JP2020-127331A, there has been known conventionally an inlet cap for covering connection mechanisms such as an AC inlet and a DC inlet formed in a vehicle charging port serving as a charging inlet. In JP2020-127331A, the charging inlet is configured such that charging can be performed by connecting a charging connector to a connection mechanism. When the charging inlet is not in use, the fitting wall of the inlet cap is inserted and fitted into a space formed around the connection mechanism, so that the connection mechanism is closed by the inlet cap. This makes it possible to suppress entry of water, dust, and the like into the interior of the connection mechanism when the charging inlet is not in use.

In this manner, when the connection mechanism is closed by the inlet cap while the charging inlet is not in use, the attachment and detachment operation of the inlet cap to and from the charging inlet is performed each time charging is performed by connecting the charging connector to the connection mechanism. Therefore, the attachment and detachment operation of the inlet cap to and from the charging inlet is performed relatively frequently.

Therefore, in manufacturing the inlet cap, in consideration of aging deterioration of the inlet cap, it is common practice to insert and fit the fitting wall of the inlet cap into the space formed around the connection mechanism with a relatively high insertion force.

### SUMMARY OF THE INVENTION

However, as in the above-described conventional technology, when the fitting wall of the inlet cap is inserted and fitted into the space formed around the connection mechanism with a relatively high insertion force, the attachment and detachment operability of the inlet cap to and from the charging inlet deteriorates. Therefore, it is desirable to improve the attachment and detachment operability of the inlet cap to and from the charging inlet. When improving the attachment and detachment operability of the inlet cap to and from the charging inlet, it is preferable that the waterproof and dustproof function of the inlet cap is not degraded.

An object of the disclosure is to provide an inlet cap that is capable of further improving the attachment and detachment operability to and from a charging inlet while suppressing degradation of a waterproof and dustproof function.

An inlet cap according to an aspect of the present disclosure is one that covers, in an openable and closable manner, a connection mechanism disposed inside a through hole formed in an inlet housing of a charging inlet, and the inlet cap includes: a cap body that faces the connection mechanism in a penetration direction of the through hole in a state of covering the connection mechanism; and a fitting wall that is connected continuously to the cap body and inserted and fitted into a space formed between the connection mechanism and the through hole, in which the fitting wall includes: a substantially tubular peripheral wall that is connected continuously from a surface of the cap body on a side facing the connection mechanism; and a rib that is formed on an outer peripheral surface of the peripheral wall so as to extend in an extension direction of the peripheral wall, and abuts against an inner circumferential surface of the inlet housing defining the through hole in a state where the peripheral wall is inserted into the space, and the fitting wall is configured such that, in a state of being inserted and fitted into the space, an end portion on a cap body side does not abut against the inner circumferential surface.

The present disclosure makes it possible to provide an inlet cap that is capable of further improving the attachment and detachment operability to and from a charging inlet while suppressing degradation of a waterproof and dustproof function.

### BRIEF DESCRIPTION OF DRAWINGS

FIG. 1 is a perspective view illustrating an example of an inlet cap.

FIG. 2 is a perspective view illustrating an example of the inlet cap and an example of a charging inlet to which the example of the inlet cap is attached.

FIG. 3 is an enlarged perspective view illustrating ribs formed in a peripheral wall body provided in an example of the inlet cap.

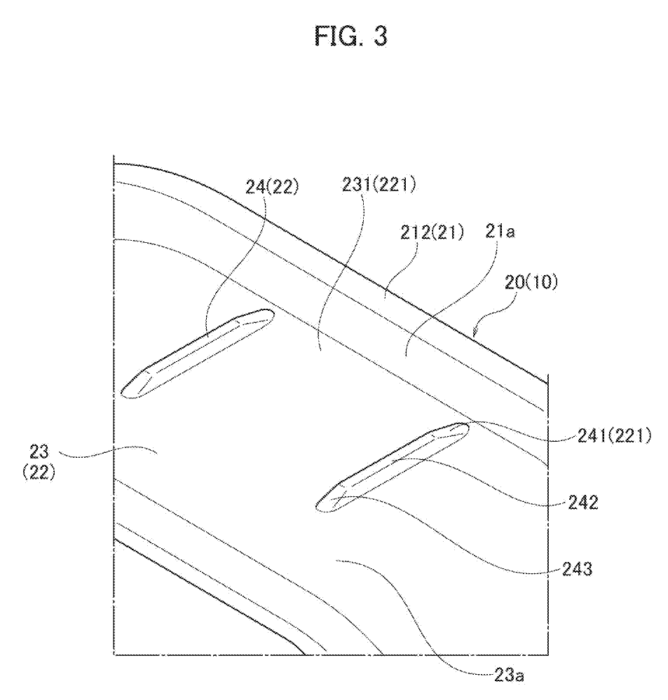

### DETAILED DESCRIPTION OF THE INVENTION

Hereinafter, an inlet cap according to the present embodiment will be described in detail with reference to the drawings. Note that the dimensional ratio of the drawings is exaggerated for illustrative purposes and may differ from the actual ratio.

The inlet cap 10 according to the present embodiment is a member that covers, in an openable and closable manner, a charging port (connection mechanism) 512 disposed inside a through hole 511 that is formed in an inlet housing 51 of a charging inlet 50. In addition, the charging inlet 50 constitutes a part of a vehicle charging section for charging a power source (not illustrated) mounted on a vehicle (not illustrated) such as an electric vehicle or a hybrid vehicle.

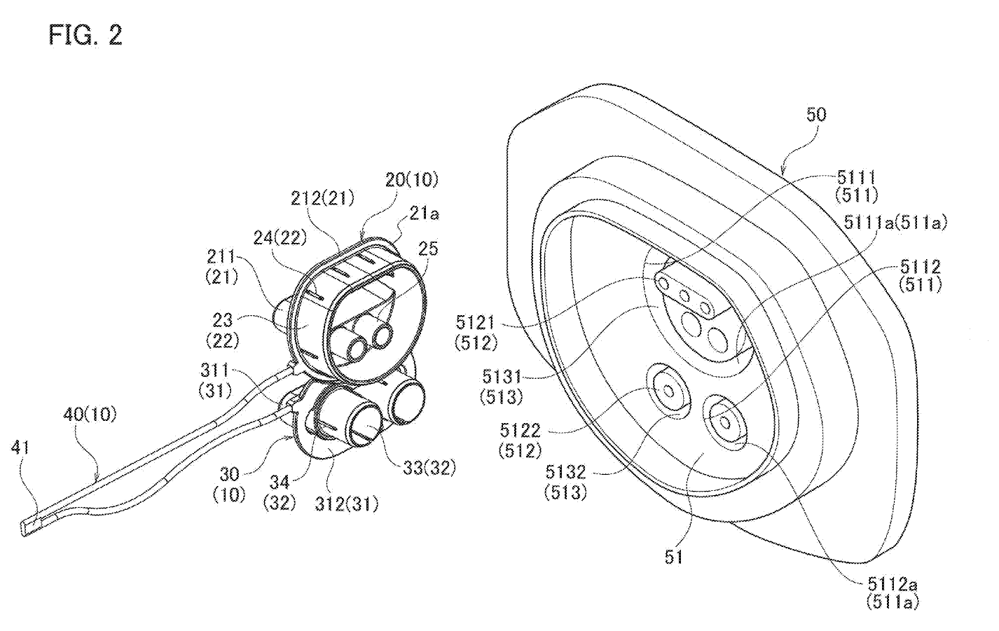

As illustrated in FIG. 2, the charging inlet 50 includes the inlet housing 51 in which the through hole 511 is formed, and the charging port (connection mechanism) 512 is disposed inside the through hole 511 in a state of being exposed from the through hole 511.

In the present embodiment, the charging port (connection mechanism) 512 is configured such that a charging connector (not illustrated) electrically connected to a charging device (not illustrated) disposed at a charging station or the like can be fitted into the charging port (connection mechanism) 512. By fitting the charging connector into the charging port (connection mechanism) 512, electric power is supplied from the charging device to the power source, and thus the power source is charged.

Further, a space 513 is formed between an inner circumferential surface 511a of the inlet housing 51 that defines the through hole 511 and the charging port (connection mechanism) 512, and the fitting wall of the inlet cap 10 is inserted and fitted into this space 513. This allows the inlet cap 10 to be removably attached to the inlet housing 51. When the inlet cap 10 is attached to the inlet housing 51, the charging port (connection mechanism) 512 is covered by the inlet cap 10. This makes it possible to suppress entry of water, dust, and the like into the interior of the charging port (connection mechanism) 512 when the charging inlet 50 is not in use.

Here, in the present embodiment, the charging inlet 50 is formed such that an AC-side charging port (AC-side connection mechanism) 5121 and a DC-side charging port (DC-side connection mechanism) 5122 serving as the charging port (connection mechanism) 512 are arranged side by side in the up-down direction.

Specifically, an AC-side through hole 5111 is formed in the upper portion of the inlet housing 51, and the AC-side charging port (AC-side connection mechanism) 5121 is disposed inside the AC-side through hole 5111 in a state of being exposed from the AC-side through hole 5111. The AC-side charging port (AC-side connection mechanism) 5121 is configured such that an AC-side charging connector (not illustrated) can be fitted into the AC-side charging port (AC-side connection mechanism) 5121. By fitting the AC-side charging connector into the AC-side charging port (AC-side connection mechanism) 5121, the power source mounted on the vehicle is charged (AC charging).

Further, a DC-side through hole 5112 is formed in the lower portion of the inlet housing 51, and the DC-side charging port (DC-side connection mechanism) 5122 is disposed inside the DC-side through hole 5112 in a state of being exposed from the DC-side through hole 5112. The DC-side charging port (DC-side connection mechanism) 5122 is configured such that a DC-side charging connector (not illustrated) can be fitted into the DC-side charging port (DC-side connection mechanism) 5122. By fitting the DC-side charging connector into the DC-side charging port (DC-side connection mechanism) 5122, the power source mounted on the vehicle is charged (DC charging).

Note that AC charging and DC charging can be performed simultaneously using one charging connector, or each of them can be performed separately using individual charging connectors.

Further, an AC-side space 5131 is formed between the AC-side inner circumferential surface 5111a of the inlet housing 51 that defines the AC-side through hole 5111 and the AC-side charging port (AC-side connection mechanism) 5121. Further, a DC-side space 5132 is formed between the DC-side inner circumferential surface 5112a of the inlet housing 51 that defines the DC-side through hole 5112 and the DC-side charging port (DC-side connection mechanism) 5122.

By inserting and fitting the fitting wall of the inlet cap 10 into each of the AC-side space 5131 and the DC-side space 5132, the inlet cap 10 is removably attached to the inlet housing 51. With this configuration, when the inlet cap 10 is attached to the inlet housing 51, the AC-side charging port (AC-side connection mechanism) 5121 and the DC-side charging port (DC-side connection mechanism) 5122 are covered by the inlet cap 10. When the AC-side charging port (AC-side connection mechanism) 5121 is not in use, entry of water, dust, and the like into the interior of the AC-side charging port (AC-side connection mechanism) 5121 can be suppressed. In addition, when the DC-side charging port (DC-side connection mechanism) 5122 is not in use, entry of water, dust, and the like into the interior of the DC-side charging port (DC-side connection mechanism) 5122 can be suppressed.

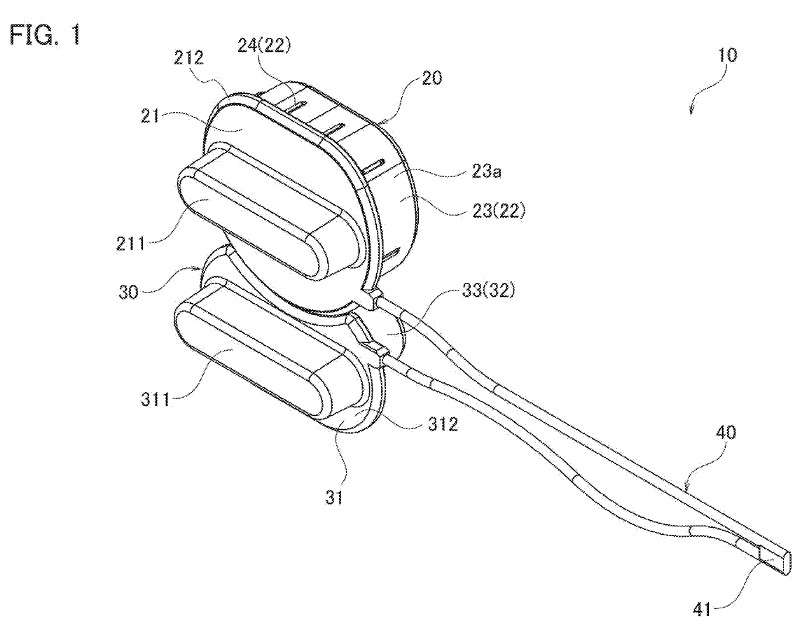

In the present embodiment, as illustrated in FIGS. 1 and 2, the inlet cap 10 includes an AC-side cap 20 and a DC-side cap 30. Further, the AC-side charging port (AC-side connection mechanism) 5121 is covered by the AC-side cap 20, and the DC-side charging port (DC-side connection mechanism) 5122 is covered by the DC-side cap 30. This allows the AC-side charging port (AC-side connection mechanism) 5121 and the DC-side charging port (DC-side connection mechanism) 5122 to be opened and closed independently. Note that it is also possible to integrate the AC-side cap 20 and the DC-side cap 30 so as to simultaneously open and close the AC-side charging port (AC-side connection mechanism) 5121 and the DC-side charging port (DC-side connection mechanism) 5122.

Further, in the present embodiment, the AC-side cap 20 and the DC-side cap 30 are each connected continuously to one end side of a pair of cord portions 40, and the other end side of the pair of cord portions 40 is connected continuously to a fixing portion 41. In this manner, in the present embodiment, the AC-side cap 20 and the DC-side cap 30 are connected via the pair of cord portions 40 and the fixing portion 41. Such an inlet cap 10 can be obtained, for example, by integral molding using a mold with a material such as an elastomer resin.

Further, by fixing the fixing portion 41 to the vehicle, the AC-side cap 20 and the DC-side cap 30 are prevented from falling off the vehicle during the attachment and detachment operation of the AC-side cap 20 and the DC-side cap 30. This prevents loss of the AC-side cap 20 and the DC-side cap 30 when charging the power source mounted on the vehicle.

Here, the AC-side cap 20 includes a plate-shaped AC-side cap body (cap body) 21. The AC-side cap body (cap body) 21 is a portion that faces the AC-side charging port (AC-side connection mechanism) 5121 in the penetration direction of the AC-side through hole 5111 when the AC-side charging port (AC-side connection mechanism) 5121 is covered by the AC-side cap 20.

Further, the AC-side cap 20 includes an AC-side fitting wall (fitting wall) 22 connected continuously to the AC-side cap body (cap body) 21. The AC-side fitting wall (fitting wall) 22 is a portion that is inserted and fitted into the AC-side space 5131 serving as the space 513 when the AC-side charging port (AC-side connection mechanism) 5121 is covered by the AC-side cap 20.

In the present embodiment, the AC-side fitting wall (fitting wall) 22 includes a substantially tubular AC-side peripheral wall (peripheral wall) 23 connected continuously from a rear surface (surface on a side facing the AC-side connection mechanism) 21a of the AC-side cap body (cap body) 21. Further, the AC-side fitting wall (fitting wall) 22 includes an AC-side rib (rib) 24 formed on the AC-side outer peripheral surface (outer peripheral surface) 23a of the AC-side peripheral wall (peripheral wall) 23 so as to extend in the extension direction of the AC-side peripheral wall (peripheral wall) 23. In the present embodiment, a plurality of AC-side ribs (ribs) 24 are formed along the circumferential direction of the AC-side peripheral wall (peripheral wall) 23.

Further, in a state where the AC-side peripheral wall (peripheral wall) 23 is inserted into the AC-side space 5131, the plurality of AC-side ribs (ribs) 24 abut against the AC-side inner circumferential surface 5111a of the inlet housing 51 that defines the AC-side through hole 5111. At this time, the AC-side peripheral wall (peripheral wall) 23 and the AC-side ribs (ribs) 24 are inserted into the AC-side space 5131 while elastically deforming. This generates a retaining force and an insertion force of the AC-side cap 20, so that the AC-side fitting wall (fitting wall) 22 is fitted into the AC-side inner circumferential surface 5111a and the AC-side cap 20 is attached to the inlet housing 51.

By attaching the AC-side cap 20 to the inlet housing 51, the AC-side charging port (AC-side connection mechanism) 5121 is covered by a portion of the AC-side cap body (cap body) 21 inside the AC-side peripheral wall (peripheral wall) 23. At this time, the AC-side peripheral wall (peripheral wall) 23 is connected continuously to an inner side of the outer peripheral edge of the AC-side cap body (cap body) 21, and an AC-side flange portion 212 that protrudes outward beyond the AC-side peripheral wall (peripheral wall) 23 is formed on the AC-side cap body (cap body) 21. When the AC-side cap 20 is attached to the inlet housing 51, the AC-side flange portion 212 abuts against a peripheral edge portion of the AC-side through hole 5111 in the inlet housing 51. This allows the AC-side through hole 5111 in which the AC-side charging port (AC-side connection mechanism) 5121 is disposed to be closed by the AC-side cap body (cap body) 21. With this configuration, it is possible to more reliably suppress entry of water, dust, and the like into the interior of the AC-side charging port (AC-side connection mechanism) 5121 when the AC-side charging port (AC-side connection mechanism) 5121 is not in use.

Further, in the present embodiment, an AC-side handle 211 is formed on the AC-side cap body (cap body) 21. By pinching the AC-side handle 211 with fingers and translating the AC-side cap 20 (the AC-side cap body 21 and the AC-side fitting wall 22) in the penetration direction of the AC-side through hole 5111, the opening and closing operation of the AC-side charging port (AC-side connection mechanism) 5121 is performed. That is, by translating the AC-side cap 20 (the AC-side cap body 21 and the AC-side fitting wall 22) in the penetration direction of the AC-side through hole 5111, the attachment and detachment operation of the AC-side cap 20 to and from the inlet housing 51 is performed.

Note that, in the present embodiment, an AC-side terminal cover 25 is formed inside the AC-side peripheral wall (peripheral wall) 23. When the AC-side cap 20 is attached to the inlet housing 51, the terminals of the AC-side charging port (AC-side connection mechanism) 5121 are protected by the AC-side terminal cover 25.

Meanwhile, the DC-side cap 30 includes a plate-shaped DC-side cap body 31. The DC-side cap body 31 is a portion that faces the DC-side charging port (DC-side connection mechanism) 5122 in the penetration direction of the DC-side through hole 5112 when the DC-side charging port (DC-side connection mechanism) 5122 is covered by the DC-side cap 30.

Further, the DC-side cap 30 includes a DC-side fitting wall 32 connected continuously to the DC-side cap body 31. The DC-side fitting wall 32 is a portion that is inserted and fitted into the DC-side space 5132 serving as the space 513 when the DC-side charging port (DC-side connection mechanism) 5122 is covered by the DC-side cap 30.

In the present embodiment, the DC-side fitting wall 32 includes a substantially tubular DC-side peripheral wall 33 connected continuously from the rear surface of the DC-side cap body 31. Further, the DC-side fitting wall 32 includes a DC-side rib 34 formed on the outer peripheral surface of the DC-side peripheral wall 33 so as to extend in the extension direction of the DC-side peripheral wall 33. In the present embodiment, a plurality of DC-side ribs 34 are formed along the circumferential direction of the DC-side peripheral wall 33.

Further, in a state where the DC-side peripheral wall 33 is inserted into the DC-side space 5132, the plurality of DC-side ribs 34 abut against the DC-side inner circumferential surface 5112a of the inlet housing 51 that defines the DC-side through hole 5112. At this time, the DC-side peripheral wall 33 and the DC-side ribs 34 are inserted into the DC-side space 5132 while elastically deforming. This generates a retaining force and an insertion force of the DC-side cap 30, so that the DC-side fitting wall 32 is fitted into the DC-side inner circumferential surface 5112a and the DC-side cap 30 is attached to the inlet housing 51.

By attaching the DC-side cap 30 to the inlet housing 51, the DC-side charging port (DC-side connection mechanism) 5122 is covered by a portion of the DC-side cap body 31 inside the DC-side peripheral wall 33. At this time, the DC-side peripheral wall 33 is connected continuously to an inner side of the outer peripheral edge of the DC-side cap body 31, and a DC-side flange portion 312 that protrudes outward beyond the DC-side peripheral wall 33 is formed on the DC-side cap body 31. When the DC-side cap 30 is attached to the inlet housing 51, the DC-side flange portion 312 abuts against a peripheral edge portion of the DC-side through hole 5112 in the inlet housing 51. This allows the DC-side through hole 5112 in which the DC-side charging port (DC-side connection mechanism) 5122 is disposed to be closed by the DC-side cap body 31. With this configuration, it is possible to more reliably suppress entry of water, dust, and the like into the interior of the DC-side charging port (DC-side connection mechanism) 5122 when the DC-side charging port (DC-side connection mechanism) 5122 is not in use.

Further, in the present embodiment, a DC-side handle 311 is formed on the DC-side cap body 31. By pinching the DC-side handle 311 with fingers and translating the DC-side cap 30 (the DC-side cap body 31 and the DC-side fitting wall 32) in the penetration direction of the DC-side through hole 5112, the opening and closing operation of the DC-side charging port (DC-side connection mechanism) 5122 is performed. That is, by translating the DC-side cap 30 (the DC-side cap body 31 and the DC-side fitting wall 32) in the penetration direction of the DC-side through hole 5112, the attachment and detachment operation of the DC-side cap 30 to and from the inlet housing 51 is performed.

Here, in the present embodiment, the attachment and detachment operability of the inlet cap 10 to and from the charging inlet 50 can be further improved while suppressing degradation of the waterproof and dustproof function.

Specifically, the AC-side fitting wall (fitting wall) 22 is configured such that, in a state of being inserted and fitted into the AC-side space 5131, a base end portion (end portion on the cap body 21 side) 221 does not abut against the AC-side inner circumferential surface 5111a (inner circumferential surface 511a).

This reduces the reaction force of the AC-side rib (rib) 24, thereby reducing the insertion force for inserting the AC-side fitting wall (fitting wall) 22 into the AC-side space 5131.

In the present embodiment, the AC-side rib (rib) 24 is formed up to a base end portion (end portion on the cap body 21 side) 231 of the AC-side peripheral wall (peripheral wall) 23. In addition, a base end portion (end portion on the cap body 21 side) 241 of the AC-side rib (rib) 24 is formed in an inclined shape such that the protrusion amount decreases toward the cap body 21.

Such a configuration can be obtained, for example, by forming the AC-side peripheral wall (peripheral wall) 23 in a general shape and then trimming the base end portion (end portion on the cap body 21 side) 241 of the AC-side rib (rib) 24. Note that the AC-side peripheral wall (peripheral wall) 23 in a general shape refers to the AC-side peripheral wall (peripheral wall) 23 that includes the AC-side rib (rib) 24 whose base end portion (end portion on the cap body 21 side) 241 also abuts against the AC-side inner circumferential surface 5111a (inner circumferential surface 511a).

Specifically, the AC-side fitting wall (fitting wall) 22 configured such that the base end portion (end portion on the cap body 21 side) 221 does not abut against the AC-side inner circumferential surface 5111a (inner circumferential surface 511a) can be formed by the following steps.

First, the inlet cap 10 (AC-side cap 20) is molded using two molds divided in the extension direction of the AC-side peripheral wall (peripheral wall) 23, thereby forming the AC-side peripheral wall (peripheral wall) 23 in a general shape.

Next, the base end portion (end portion on the cap body 21 side) 241 of the AC-side rib (rib) 24 included in the AC-side peripheral wall (peripheral wall) 23 in general shape is trimmed, and the base end portion (end portion on the cap body 21 side) 241 is inclined such that the protrusion amount decreases toward the cap body 21.

This forms the AC-side fitting wall (fitting wall) 22 configured such that the base end portion (end portion on the cap body 21 side) 221 does not abut against the AC-side inner circumferential surface 5111a (inner circumferential surface 511a).

In this way, without using a mold with a complicated shape, it becomes possible to form the AC-side fitting wall (fitting wall) 22 such that the base end portion (end portion on the cap body 21 side) 221 does not abut against the AC-side inner circumferential surface 5111a (inner circumferential surface 511a).

Note that the base end portion (end portion on the cap body 21 side) 221 of the AC-side fitting wall (fitting wall) 22 is composed of the base end portion (end portion on the cap body 21 side) 231 of the AC-side peripheral wall (peripheral wall) 23 and the base end portion (end portion on the cap body 21 side) 241 of the AC-side rib (rib) 24. Further, when the AC-side fitting wall (fitting wall) 22 is inserted and fitted into the AC-side space 5131, the base end portion (end portion on the cap body 21 side) 231 and the base end portion (end portion on the cap body 21 side) 241 are each configured not to abut against the AC-side inner circumferential surface 5111a (inner circumferential surface 511a).

This prevents the base end portion (end portion on the cap body 21 side) 241, where the reaction force is large, from abutting against the AC-side inner circumferential surface 5111a (inner circumferential surface 511a), thereby reducing the reaction force of the AC-side rib (rib) 24. As a result, the insertion force for inserting the AC-side fitting wall (fitting wall) 22 into the AC-side space 5131 is reduced.

Further, in the present embodiment, the AC-side rib (rib) 24 includes a base end portion (end portion on the cap body 21 side) 241, a main body portion 242, and a distal end portion 243, and the distal end portion 243 is formed in an inclined shape such that the protrusion amount decreases toward the distal end. In this manner, in the present embodiment, the AC-side rib (rib) 24 has a substantially trapezoidal shape in side view. Further, when the AC-side fitting wall (fitting wall) 22 is inserted and fitted into the AC-side space 5131, the main body portion 242 abuts against the AC-side inner circumferential surface 5111a (inner circumferential surface 511a).

In this manner, in the present embodiment, the portion from the distal end side to the middle portion of the AC-side rib (rib) 24, where the reaction force is relatively low, is brought into abutment against the AC-side inner circumferential surface 5111a (inner circumferential surface 511a). Further, the base end portion (end portion on the cap body 21 side) 241 of the AC-side rib (rib) 24, where the reaction force is relatively high, is not brought into abutment against the AC-side inner circumferential surface 5111a (inner circumferential surface 511a).

At this time, it is preferable to appropriately set the length of the base end portion (end portion on the cap body 21 side) 221 of the AC-side fitting wall (fitting wall) 22, the length of the portion of the AC-side rib (rib) 24 that abuts against the AC-side inner circumferential surface 5111a (inner circumferential surface 511a), and the like. This makes it possible to reduce the insertion force of the AC-side fitting wall (fitting wall) 22 within a range in which the waterproof and dustproof function of the AC-side charging port (AC-side connection mechanism: connection mechanism) 5121 can be exhibited. That is, it becomes possible to set (adjust) the insertion force of the AC-side fitting wall (fitting wall) 22 so as to achieve a desired insertion force.

Further, in the present embodiment, a plurality of AC-side ribs (ribs) 24 are formed to be spaced apart on the AC-side peripheral wall (peripheral wall) 23 along the circumferential direction of the AC-side peripheral wall (peripheral wall) 23.

This makes it possible to suppress variation in the retaining force and the insertion force of the AC-side cap 20 in the circumferential direction generated when the AC-side rib (rib) 24 is brought into abutment against the AC-side inner circumferential surface 5111a (inner circumferential surface 511a). As a result, it becomes possible to further improve the attachment and detachment operability to and from the charging inlet 50 while suppressing degradation of the waterproof and dustproof function.

Further, in the present embodiment, the opening and closing operation of the AC-side charging port (AC-side connection mechanism) 5121 is performed by translating the AC-side cap 20 (the AC-side cap body 21 and the AC-side fitting wall 22) in the penetration direction of the AC-side through hole 5111.

This allows the AC-side peripheral wall (peripheral wall) 23 to be made longer than in a case where the AC-side cap 20 (the AC-side cap body 21 and the AC-side fitting wall 22) is rotated by a hinge structure. As a result, a larger contact margin of the AC-side rib (rib) 24 with the AC-side inner circumferential surface 5111a (inner circumferential surface 511a) can be secured, thereby making it possible to achieve relaxed dimensional accuracy. In addition, by configuring the AC-side cap 20 (the AC-side cap body 21 and the AC-side fitting wall 22) to be translated in the penetration direction of the AC-side through hole 5111, the insertion force of the AC-side fitting wall (fitting wall) 22 can be set (adjusted) more easily.

### Operation and Effects

Hereinafter, characteristic configurations of the inlet cap illustrated in the above embodiment, and effects obtained thereby will be described.

The inlet cap 10 shown in the above embodiment covers, in an openable and closable manner, the AC-side charging port (AC-side connection mechanism: connection mechanism) 5121 disposed inside the AC-side through hole (through hole) 5111 that is formed in the inlet housing 51 of the charging inlet 50.

The inlet cap 10 includes the AC-side cap body (cap body) 21. Here, the AC-side cap body (cap body) 21 is formed so as to face the AC-side charging port (AC-side connection mechanism: connection mechanism) 5121 in the penetration direction of the AC-side through hole (through hole) 5111 in a state of covering the AC-side charging port (AC-side connection mechanism: connection mechanism) 5121.

In addition, the inlet cap 10 includes the AC-side fitting wall (fitting wall) 22 connected continuously to the AC-side cap body (cap body) 21. The AC-side fitting wall (fitting wall) 22 is a portion that is inserted and fitted into the AC-side space 5131 serving as the space 513 formed between the AC-side charging port (AC-side connection mechanism: connection mechanism) 5121 and the AC-side through hole (through hole) 5111.

Further, the AC-side fitting wall (fitting wall) 22 includes the substantially tubular AC-side peripheral wall (peripheral wall) 23 connected continuously from a rear surface (surface on a side facing the AC-side connection mechanism) 21a of the AC-side cap body (cap body) 21. Further, the AC-side fitting wall (fitting wall) 22 includes an AC-side rib (rib) 24 formed on the AC-side outer peripheral surface (outer peripheral surface) 23a of the AC-side peripheral wall (peripheral wall) 23 so as to extend in the extension direction of the AC-side peripheral wall (peripheral wall) 23. The AC-side rib (rib) 24 is a portion that abuts against the AC-side inner circumferential surface 5111a (inner circumferential surface 511a) of the inlet housing 51 that defines the AC-side through hole 5111 in a state where the AC-side peripheral wall (peripheral wall) 23 is inserted into the AC-side space 5131.

Further, the AC-side fitting wall (fitting wall) 22 is configured such that, in a state of being inserted and fitted into the AC-side space 5131, the base end portion (end portion on the cap body 21 side) 221 does not abut against the AC-side inner circumferential surface 5111a (inner circumferential surface 511a).

In this manner, in the inlet cap 10 shown in the above embodiment, the base end portion (end portion on the cap body 21 side) 221 of the AC-side fitting wall (fitting wall) 22 is not brought into abutment against the AC-side inner circumferential surface 5111a (inner circumferential surface 511a). The base end portion (end portion on the cap body 21 side) 221 of the AC-side fitting wall (fitting wall) 22 is a portion that is difficult to deflect and deform when inserted into the AC-side space 5131 and where the reaction force is large. Therefore, by not bringing the base end portion (end portion on the cap body 21 side) 221 of the AC-side fitting wall (fitting wall) 22 into abutment against the AC-side inner circumferential surface 5111a (inner circumferential surface 511a), it becomes possible to reduce the reaction force of the AC-side rib (rib) 24. As a result, the insertion force of the AC-side fitting wall (fitting wall) 22 into the AC-side space 5131 can be reduced.

Further, in the inlet cap 10 shown in the above embodiment, the AC-side rib (rib) 24 positioned on the distal end side of the base end portion (end portion on the cap body 21 side) 221 of the AC-side fitting wall (fitting wall) 22 is brought into abutment against the AC-side inner circumferential surface 5111a (inner circumferential surface 511a). This ensures the retaining force of the AC-side fitting wall (fitting wall) 22 with respect to the inlet housing 51 by means of the abutment portion of the AC-side rib (rib) 24 with the AC-side inner circumferential surface 5111a (inner circumferential surface 511a).

This makes it possible to further improve the attachment and detachment operability to and from the charging inlet 50 while suppressing degradation of the waterproof and dustproof function.

At this time, it is preferable to appropriately set the length of the base end portion (end portion on the cap body 21 side) 221 of the AC-side fitting wall (fitting wall) 22, the length of the portion of the AC-side rib (rib) 24 that abuts against the AC-side inner circumferential surface 5111a (inner circumferential surface 511a), and the like. This makes it possible to reduce the insertion force of the AC-side fitting wall (fitting wall) 22 within a range in which the waterproof and dustproof function of the AC-side charging port (AC-side connection mechanism: connection mechanism) 5121 can be exhibited. That is, it becomes possible to set (adjust) the insertion force of the AC-side fitting wall (fitting wall) 22 so as to achieve a desired insertion force.

Further, by reducing the reaction force of the AC-side rib (rib) 24, a larger contact margin of the AC-side rib (rib) 24 with the AC-side inner circumferential surface 5111a (inner circumferential surface 511a) can be secured, thereby making it possible to achieve relaxed dimensional accuracy.

Further, the AC-side rib (rib) 24 may be formed up to the base end portion (end portion on the cap body 21 side) 231 of the AC-side peripheral wall (peripheral wall) 23. In addition, the base end portion (end portion on the cap body 21 side) 241 of the AC-side rib (rib) 24 may be formed in an inclined shape such that the protrusion amount decreases toward the cap body 21.

In this way, by trimming the base end portion (end portion on the cap body 21 side) 241 of the AC-side rib (rib) 24, the base end portion (end portion on the cap body 21 side) 221 of the AC-side fitting wall (fitting wall) 22 can be configured so as not to abut against the AC-side inner circumferential surface 5111a (inner circumferential surface 511a).

In this manner, by trimming the base end portion (end portion on the cap body 21 side) 241 of the AC-side rib (rib) 24, it becomes unnecessary to use a complicated mold. That is, without using a mold with a complicated shape, it becomes possible to form the AC-side fitting wall (fitting wall) 22 such that the base end portion (end portion on the cap body 21 side) 221 does not abut against the AC-side inner circumferential surface 5111a (inner circumferential surface 511a).

Specifically, the AC-side fitting wall (fitting wall) 22 configured such that the base end portion (end portion on the cap body 21 side) 221 does not abut against the AC-side inner circumferential surface 5111a (inner circumferential surface 511a) can be formed by the following steps.

First, the inlet cap 10 (AC-side cap 20) is molded using two molds divided in the extension direction of the AC-side peripheral wall (peripheral wall) 23, thereby forming the AC-side peripheral wall (peripheral wall) 23 in a general shape. Note that the AC-side peripheral wall (peripheral wall) 23 in a general shape refers to the AC-side peripheral wall (peripheral wall) 23 that includes the AC-side rib (rib) 24 whose base end portion (end portion on the cap body 21 side) 241 also abuts against the AC-side inner circumferential surface 5111a (inner circumferential surface 511a).

Next, the base end portion (end portion on the cap body 21 side) 241 of the AC-side rib (rib) 24 included in the AC-side peripheral wall (peripheral wall) 23 in general shape is trimmed. This causes the base end portion (end portion on the cap body 21 side) 241 to be formed in an inclined shape such that the protrusion amount decreases toward the cap body 21.

This forms the AC-side fitting wall (fitting wall) 22 configured such that the base end portion (end portion on the cap body 21 side) 221 does not abut against the AC-side inner circumferential surface 5111a (inner circumferential surface 511a).

In this way, without using a mold with a complicated shape, it becomes possible to form the AC-side fitting wall (fitting wall) 22 such that the base end portion (end portion on the cap body 21 side) 221 does not abut against the AC-side inner circumferential surface 5111a (inner circumferential surface 511a).

Further, a plurality of AC-side ribs (ribs) 24 may be formed on the AC-side peripheral wall (peripheral wall) 23 along the circumferential direction of the AC-side peripheral wall (peripheral wall) 23.

This makes it possible to suppress variation in the retaining force and the insertion force of the AC-side cap 20 in the circumferential direction generated when the AC-side rib (rib) 24 is brought into abutment against the AC-side inner circumferential surface 5111a (inner circumferential surface 511a). As a result, it becomes possible to further improve the attachment and detachment operability to and from the charging inlet 50 while suppressing degradation of the waterproof and dustproof function.

Further, the opening and closing operation of the AC-side charging port (AC-side connection mechanism) 5121 may be performed by translating the AC-side cap 20 (the AC-side cap body 21 and the AC-side fitting wall 22) in the penetration direction of the AC-side through hole 5111.

This allows the AC-side peripheral wall (peripheral wall) 23 to be made longer than in a case where the AC-side cap 20 (the AC-side cap body 21 and the AC-side fitting wall 22) is rotated by a hinge structure. As a result, a larger contact margin of the AC-side rib (rib) 24 with the AC-side inner circumferential surface 5111a (inner circumferential surface 511a) can be secured, thereby making it possible to achieve relaxed dimensional accuracy. In addition, by configuring the AC-side cap 20 (the AC-side cap body 21 and the AC-side fitting wall 22) to be translated in the penetration direction of the AC-side through hole 5111, the insertion force of the AC-side fitting wall (fitting wall) 22 can be set (adjusted) more easily.

### Others

Although the present embodiment has been described above, the present embodiment is not limited thereto, and various modifications are possible within the scope of the gist of the present embodiment.

For example, in the above embodiment, an example has been given in which the AC-side fitting wall 22 is configured such that the AC-side rib 24 is formed up to the base end portion 231 of the AC-side peripheral wall 23, and the base end portion 241 of the AC-side rib 24 is inclined such that the protrusion amount decreases toward the cap body 21. However, the AC-side fitting wall 22 does not need to have such a configuration, and various configurations are possible. For example, it is also possible to form the base end portion 221 of the AC-side fitting wall 22 so as not to abut against the AC-side inner circumferential surface 5111a by not forming the AC-side rib 24 at the base end portion 231 of the AC-side peripheral wall 23.

In the above embodiment, an example has been given in which the present invention is applied to the AC-side cap 20; however, it is also possible to apply the present invention to the DC-side cap 30.

Further, the specifications (shape, size, layout, etc.) of the cap bodies, fitting walls, and other particulars may also be changed as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An inlet cap that covers, in an openable and closable manner, a connection mechanism disposed inside a through hole formed in an inlet housing of a charging inlet, the inlet cap comprising:
a cap body that faces the connection mechanism in a penetration direction of the through hole in a state of covering the connection mechanism; and
a fitting wall that is connected continuously to the cap body and inserted and fitted into a space formed between the connection mechanism and the through hole,
wherein the fitting wall includes:
a substantially tubular peripheral wall that is connected continuously from a surface of the cap body on a side facing the connection mechanism; and
a rib that is formed on an outer peripheral surface of the peripheral wall so as to extend in an extension direction of the peripheral wall, and abuts against an inner circumferential surface of the inlet housing defining the through hole in a state where the peripheral wall is inserted into the space, and
the fitting wall is configured such that, in a state of being inserted and fitted into the space, an end portion on a cap body side does not abut against the inner circumferential surface.

2. The inlet cap according to claim 1, wherein
the rib is formed up to an end portion of the peripheral wall on the cap body side, and
an end portion of the rib on the cap body side is formed in an inclined shape such that a protrusion amount decreases toward the cap body.

3. The inlet cap according to claim 1,
wherein a plurality of ribs are formed on the peripheral wall along a circumferential direction of the peripheral wall.

4. The inlet cap according to claim 1,
wherein an opening and closing operation of the connection mechanism is performed by translating the cap body and the fitting wall in the penetration direction of the through hole.
